(19) United States
(12) Patent Application Publication
(10) Pub. No.: US 2016/0004078 A1
(43) Pub. Date: Jan. 7, 2016

(54) Optical Head Mounted Display Cover

(71) Applicant: Michael Mullins, Indianapolis, IN (US)

(72) Inventor: Michael Mullins, Indianapolis, IN (US)

(21) Appl. No.: 14/790,954

(22) Filed: Jul. 2, 2015

Related U.S. Application Data
(60) Provisional application No. 62/020,122, filed on Jul. 2, 2014.

(51) Int. Cl. G02B 27/01; H04N 5/225

(52) U.S. Cl. CPC G02B 27/017; H04N 5/225; G02B 2027/0178; G02B 2027/0138

(57) ABSTRACT

A cover for obstructing the camera of an optical head mounted display is provided. The cover comprises a sleeve having a cavity adapted to slide over an optical head mounted display camera. The sleeve removably attaches to the optical head mounted display camera via snap connectors located within the cavity of the sleeve. The sleeve is sufficiently flexible to accept insertion of the optical head mounted display camera and securely retain the optical head mounted display camera therein. The cover further includes an indicator on an exterior surface thereof designating that the optical head mounted display camera is not operational.

### CROSS REFERENCE TO RELATED APPLICATION

This application claims the benefit of U.S. Provisional Application No. 62/020,122 filed on Jul. 2, 2014. The above identified patent application is herein incorporated by reference in its entirety to provide continuity of disclosure.

### BACKGROUND OF THE INVENTION

1. Field of the Invention

The present invention relates to a cover for an optical head mounted display camera. More specifically, the present invention relates to a cover for obstructing the camera of an optical head mounted display comprising a sleeve having a cavity adapted to slide over an optical head mounted display camera and removably attach thereto. The sleeve removably attaches to an optical head mounted display camera via snap connectors located within the cavity of the sleeve so as to block the view of the camera.

Optical head mounted displays (hereinafter “OHMDs”) are wearable displays that have the capability of reflecting projected images to allow a user to see the images on a curved lens. OHMDs commonly include cameras that actively record and take pictures according to a user preference. For example, OHMDs like Google Glasses® and other similar OHMDs, have the ability to capture video and images of surrounding individuals without permission from those individuals. This capability can make people very uncomfortable, especially in public restrooms and other similar areas. Users can choose to remove the OHMD when entering these areas where people expect privacy, but this can be very inconvenient. Therefore, there is a need for a device that blocks an OHMD's video recording capabilities and indicates to surrounding people that the user is not recording without their permission.

Although OHMDs generally only record video or capture pictures when instructed to by the user, surrounding individuals have no way of knowing if the individual is actively recording video at the time. This uncertainty can make individuals very uncomfortable if they are in a situation where they expect privacy, such as a public bathroom. The present invention thereby provides a means for ensuring surrounding individuals that their privacy is being protected. The present invention contemplates a device that can be removably attached to a camera display of an OHMD, such as the Google Glasses®, whereby the device slides over the camera and obstructs the camera from taking pictures or recording. Specifically, the cover includes a sleeve having cavity with snap connectors that attach to the camera and is supported therein.

Many applications of the OHMD cover are contemplated, and thus is not limited to single type of OHMD. It is not desired to limit the type of OHMD device that can be utilized nor is it desired to limit the specific type of cover attached to the OHMD. Rather, it is desired to disclose a new and novel device for covering an OHMD with a sleeve that obstructs the view of the camera and does not interfere with normal operation of the OHMD.

### SUMMARY OF THE INVENTION

In view of the foregoing disadvantages inherent in the known types of optical head mounted display covers now present in the prior art, the present invention provides a new and improved optical head mounted display cover wherein the same can be utilized for providing convenience for the user when obstructing the camera for a limited time in certain public areas.

It is therefore an object of the present invention to provide a cover for an optical head mounted display comprising a sleeve having a cavity adapted to slide over an optical head mounted display camera and removably attach thereto.

It is therefore an object of the present invention to provide a cover for an optical head mounted display including a sleeve that removably attaches to an optical head mounted display camera via snap connectors located within the cavity of the sleeve. The sleeve further includes a first portion and a second portion. The first portion is a rectangular housing that fits over the camera and the second portion is a curved housing adapted to receive a contour of the optical head mounted display camera.

It is therefore an object of the present invention to provide a cover for an optical head mounted display including a sleeve that is sufficiently flexible to accept insertion of the optical head mounted display camera and securely retain the optical head mounted display camera therein. The cover further includes an indicator on an exterior surface thereof designating that the optical head mounted display camera is not operational.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of the optical head mounted display cover according to one embodiment of the present invention.

FIG. 2 shows a rear view of the optical head mounted display cover according to one embodiment of the present invention.

FIG. 3 shows the optical head mounted display cover attached to the camera of an OHMD according to one embodiment of the present invention.

### DETAILED DESCRIPTION OF THE INVENTION

Reference is made herein to the attached drawings. Like reference numerals are used throughout the drawings to depict like or similar elements of the cover for an optical head mounted display. For the purposes of presenting a brief and clear description of the present invention, the preferred embodiment will be discussed as used for obstructing the view of the camera on an optical head mounted display. The figures are intended for representative purposes only and should not be considered to be limiting in any respect.

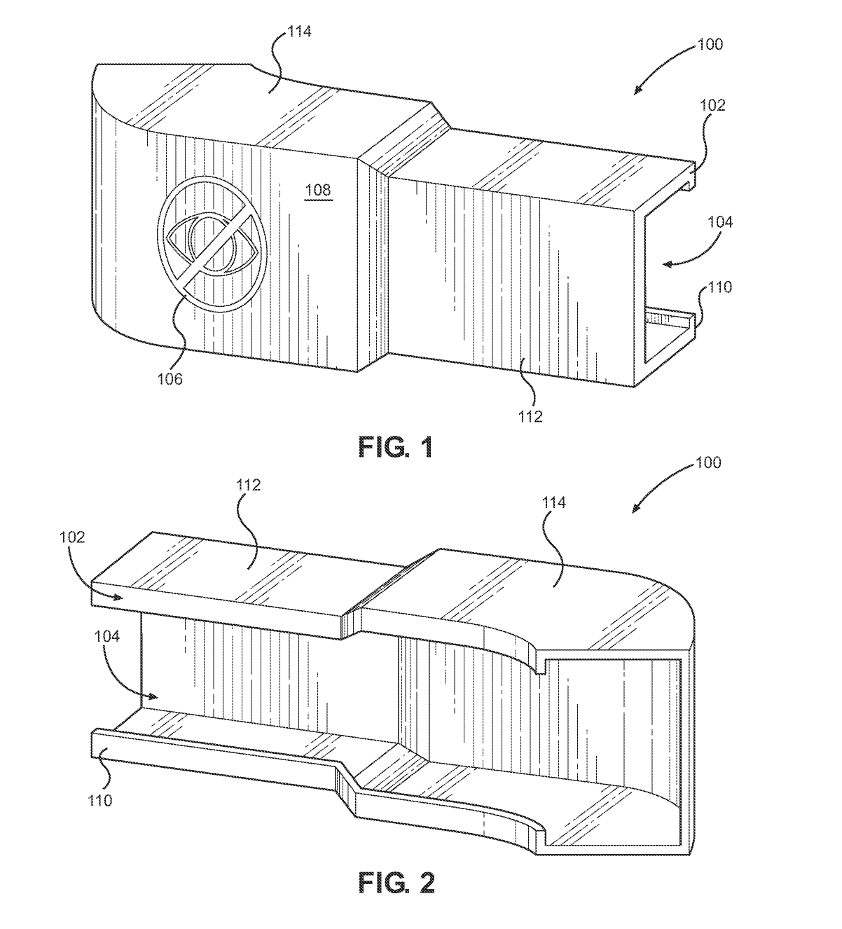

Referring now to FIGS. 1 and 2, there are shown views of the optical head mounted display cover according embodiments of the present invention. The optical head mounted display cover 100 provides a slidable cover that obstructs the view of an optical head mounted display camera without interfering with other functions of the optical head mounted display. The cover 100 includes an indicator 106 on the exterior surface 108 thereof such that others are notified that the camera of the optical head mounted display is non-operational. The cover 100 comprises a sleeve 102 that fits snugly over the camera of an OHMD. The sleeve 102 is substantially rectangular, however, it is contemplated that the sleeve 102 may have other shapes that match the contours of other OHMDs and OHMD cameras.

The sleeve 102 includes a cavity 104 adapted to slide over an optical head mounted display camera. The interior of the cavity 104 includes a plurality of snap connectors 110 that securely fasten the cover 100 to the OHMD camera. The sleeve 102 is fabricated from a material that is sufficiently flexible to accept insertion of the optical head mounted display camera and securely retain the optical head mounted display camera therein. The sleeve 102 may be fabricated from plastic, molded plastic, aluminum, vinyl, silicone, or hard plastic.

The sleeve 102 further comprises a first portion 112 and a second portion 114 integrally attached to one another. The first portion 112 is a rectangular housing that is adapted to cover the prism of the OHMD. The prism reflects images from the projector onto the display of the OHMD. The second portion 114 of the sleeve 102 is a curved housing adapted to slide over a contour of the OHMD camera. The second portion 114 is configured to obstruct the view of the camera rendering it inoperable. Both the first portion 112 and the second portion 114 each include snap connectors that removably attach to the prism and the camera housing, respectively. The exterior surface 108 of the second portion 114 has the indicator 106 thereon, wherein the indicator 106 indicates the OHMD camera is not operational.

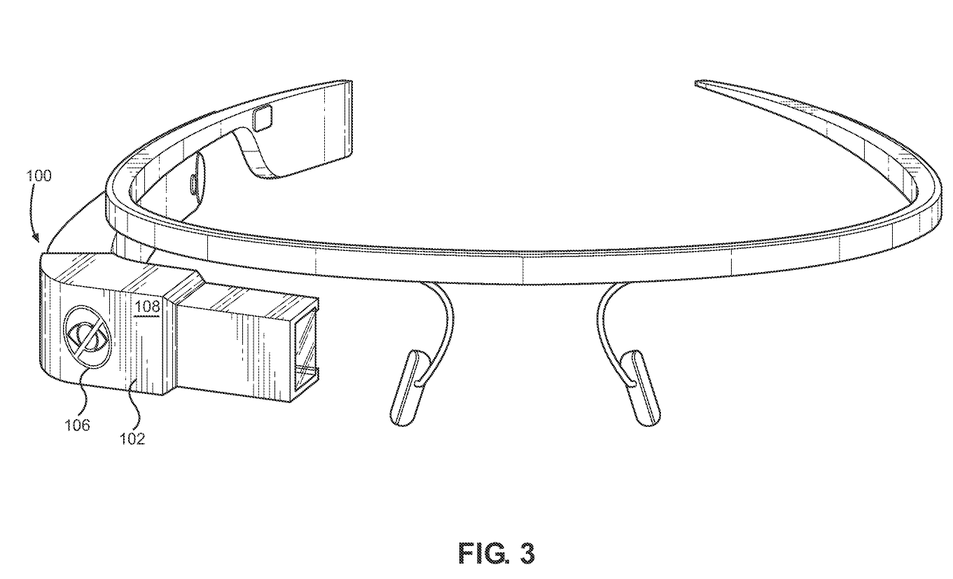

Referring now to FIG. 3, there is shown the optical head mounted display cover attached to the camera of an OHMD according to one embodiment of the present invention. The present invention comprises a cover 100 having a sleeve 102 that is configured to slide over the portion of an OHMD housing, the video recording camera, and the display screen. In this way, the sleeve is removably attached thereto and allows the present invention to obstruct the OHMD's video recording and display capabilities in order to ensure surrounding individuals that they are not being recorded or photographed without their permission. This is particularly advantageous, as the cover 100 does not block the OHMD's visibility. The cover 100 further comprises an indicator 106 disposed on the exterior surface 108 of the sleeve 102 to further indicate to individuals that they are not being recorded.

The illustrated embodiment in FIG. 3 shows a view of the cover 100 placed in position over the camera of an OHMD device. The cover 100 is adapted for use with Google Glasses® and other similar OHMDs having a side pod housing the video camera, display screen, CPU, and other such components. Conventionally, the camera of the OHMD is positioned in front the display, wherein the camera is also adjacent to a prism so as to reflect images onto the display. In some embodiments, the sleeve 102 of the cover 100 is adapted to cover both the camera and the prism such that the user cannot project images from the camera. In other embodiments, the sleeve 102 includes snap connectors that removably attach to the camera such that the cover 100 does not interfere with the other functions of the OHMD.

When the cover 100 is placed over the OHMD, the exterior surface 108 faces outwardly toward the general public. The exterior surface 108 includes the indicator 106 indicating to others that the OHMD camera is not operational. In this way, people can be assured that an OHMD camera is covered by the sleeve 102 and is not recording.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A cover for optical head mounted displays, comprising:
a sleeve having a cavity adapted to slide over an optical head mounted display camera and obstruct the optical head mounted display camera;
a snap connector within the cavity of the sleeve;
wherein the sleeve is sufficiently flexible to accept insertion of the optical head mounted display camera and securely retain the optical head mounted display camera therein.

2) The cover of claim 1, wherein the sleeve further comprises a first portion and a second portion.

3) The cover of claim 2, wherein the first portion is rectangular housing adapted to cover a prism of the optical head mounted display camera.

4) The cover of claim 2, wherein the second portion is curved housing adapted to receive a contour of the optical head mounted display camera

5) The cover of claim 2, wherein the first portion and the second portion each include the snap connector.

6) The cover of claim 1, wherein the sleeve further includes an exterior surface having an indicator thereon, wherein the indicator indicates the OHMD camera is not operational.
